(19) United States
(12) Patent Application Publication
(10) Pub. No.: US 2007/0261680 A1
(43) Pub. Date: Nov. 15, 2007

(54) Inlet air heater system

(76) Inventors: Tracy M. Farell, Grand Blanc, MI (US); Iain J. Read, Wixom, MI (US); Edward R. Romblom, De Witt, MI (US); Donald K. Hamilton, North Tonawanda, NY (US); Robert J. Moran, Ann Arbor, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/434,099

(22) Filed: May 15, 2006

(51) Int. Cl. F02G 5/00

(52) U.S. Cl. 123/556

(57) ABSTRACT

An internal combustion engine is provided having a first and second bank of cylinder bores arranged in a generally V-shaped configuration. The internal combustion engine includes a first and second intake manifold each having a plenum and at least one intake runner. The first and second intake manifolds are mounted to the internal combustion engine in an outboard position. An inlet air duct communicates inlet air to each of the first and second intake manifolds. A first and second inlet air heater is disposed substantially adjacent to the respective plenums of the first and second intake manifold. The first and second inlet air heaters operate to selectively heat the inlet air prior to entering the respective plenums of the first and second intake manifold. The first and second inlet air heaters may include at least one of driver circuitry and diagnostic circuitry.

### TECHNICAL FIELD

The present invention relates to inlet air heaters for internal combustion engines.

### BACKGROUND OF THE INVENTION

Compression ignited internal combustion engines such as diesel engines are highly efficient as a result of high compression ratios. At operating temperature, the combustion event within the compression ignited engine is characterized as controlled auto-ignition. The heat energy produced by the compression of an inlet air and fuel charge mixture initiates the combustion event, while other engine types, such as spark ignited engines, require a spark or other ignition source to initiate the combustion event. Compression ignited engines operating at low engine load in a low ambient air temperature environment may produce “white smoke” exhaust emissions. This white smoke can be attributed to the release of unburned hydrocarbons as a result of misfire or incomplete combustion within the engine. The low temperature ambient air and low engine load operate to reduce the temperature of the charge mixture within the engine to a degree that the combustion event becomes unstable.

### SUMMARY OF THE INVENTION

An inlet air heater system is provided for an internal combustion engine having a generally V-shaped cylinder configuration. The inlet air heater system includes a first and second intake manifold having a respective first and second plenum and at least one intake runner in communication with each of the first and second plenums. The first and second intake manifolds operate to communicate inlet air to the internal combustion engine. An intake duct operates to communicate the inlet air to the first and second plenum of the respective first and second intake manifold. A respective first and second inlet air heater is mounted in close-coupled relation to one of the first and second intake manifold and operates to selectively heat the inlet air prior to the inlet air entering the first and second plenums. The first and second intake manifolds are mounted to the internal combustion engine outboard of the V-shaped cylinder configuration.

The inlet air heater system may include driver circuitry operable to provide power to effect operation of the first and second inlet air heaters and diagnostic circuitry operable to detect malfunctions in the operation of the first and second inlet air heaters. At least one of the driver circuitry and diagnostic circuitry may be mounted with respect to at least one of the first and second inlet air heaters. Alternately, a remotely mounted controller may be provided having at least one of the driver circuitry and diagnostic circuitry. Additionally, the second inlet air heater may be powered in a series relation with respect to the first inlet air heater. An internal combustion engine incorporating the disclosed inlet air heater system is also provided.

The above features and advantages and other features and advantages of the present invention are readily apparent from the following detailed description of the best modes for carrying out the invention when taken in connection with the accompanying drawing.

### BRIEF DESCRIPTION OF THE DRAWING

FIG. 1 is a schematic diagrammatic illustration of a compression ignited internal combustion engine incorporating an inlet air heater system consistent with the present invention.

### DESCRIPTION OF THE PREFERRED EMBODIMENT

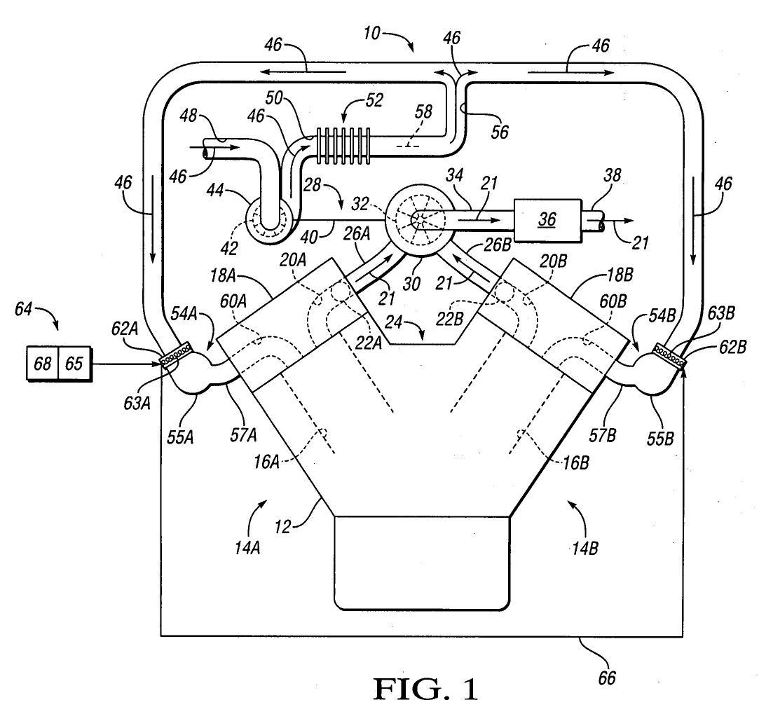

Referring to the drawings wherein like reference numbers correspond to like or similar components throughout the several figures, there is shown in FIG. 1 an internal combustion engine, generally indicated at 10. For discussion herein, the internal combustion engine 10 preferably operates in a compression ignited or diesel mode of operation. The internal combustion engine 10 has a cylinder case 12 with a generally V-type configuration. In a V-type configuration, a first and a second bank of cylinder bores 14A and 14B, respectively, of the cylinder case 12 are disposed with an included angle of less than 180 degrees relative to each other. Those skilled in the art will recognize that each of the first and second banks of cylinder bores 14A and 14B may each define one or a plurality of respective cylinder bores 16A and 16B. First and second cylinder heads 18A and 18B are mounted to the first and second bank of cylinder bores 14A and 14B, respectively.

Each of the first and second cylinder heads 18A and 18B define respective exhaust ports 20A and 20B through which products of combustion or exhaust gases 21 are selectively evacuated from the respective cylinder bores 16A and 16B. The exhaust ports 20A and 20B communicate exhaust gases 21 to a respective one of a first and second integral exhaust manifold 22A and 22B, each defined within the first and second cylinder head 18A and 18B, respectively. Since the integrated exhaust manifolds 22A and 22B are formed integrally with the cylinder heads 18A and 18B, respectively, the number of potential exhaust gas leak paths during operation of the internal combustion engine 10 is reduced.

The first and second integral exhaust manifolds 22A and 22B are positioned on the internal combustion engine 10 such that they discharge exhaust gases 21 in an inboard configuration, i.e. the first and second integral exhaust manifolds 22A and 22B are disposed substantially adjacent to an inboard region or generally V-shaped cavity 24. The generally V-shaped cavity 24 is at least partially defined by the first and second cylinder heads 18A and 18B and the first and second bank of cylinder bores 14A and 14B. The inboard exhaust discharge configuration is beneficial in that the packaging space required by the engine 10 may be reduced. The integral exhaust manifolds 22A and 22B may discharge in any orientation within the general area defined by the generally V-shaped cavity 24 while remaining within the scope of that which is claimed. A respective first and second discharge conduit or pipe 26A and 26B are in fluid communication with the first and second integral exhaust manifolds 22A and 22B, respectively.

The internal combustion engine 10 also includes a turbocharger assembly 28 positioned substantially within the generally V-shaped cavity 24. The turbo charger assembly 28 includes a turbine housing 30 into which the first and second discharge pipes 26A and 26B communicate exhaust gases 21. Those skilled in the art will recognize that the first and second discharge pipes 26A and 26B may be eliminated by respectively incorporating the first and second discharge pipes 26A and 26B into one of the turbine housing 30 and the first and second cylinder heads 18A and 18B. The energy contained within the exhaust gases 21 cause a turbine blade 32 to spin or rotate within the turbine housing 30. The turbine housing 30 preferably has a variable geometry. The exhaust gases 21 are subsequently communicated to a discharge pipe 34. The discharge pipe 34 communicates the exhaust gases 21 to a diesel particulate filter, or DPF 36. The DPF 36 contains a separation medium that captures particulate matter, such as soot, contained within the exhaust gases 21. A DPF discharge pipe 38 communicates exhaust gases 21 to the remainder of the exhaust system, not shown.

The inboard configuration of the first and second integral exhaust manifolds 18A and 18B permit the length of the first and second discharge pipes 26A and 26B to be minimized or eliminated. By minimizing the length of the first and second discharge pipes 26A and 26B, much of the heat energy of the exhaust gases 21 may be retained and therefore communicated to the turbocharger assembly 28. This heat energy would otherwise be lost to the atmosphere through heat transfer. Those skilled in the art will recognize that the present invention may incorporate a single turbocharger assembly, such as 28, or twin turbochargers, or staged turbochargers.

The turbine blade 32 is rigidly connected, through a shaft 40, to a compressor blade 42 for unitary rotation therewith. The rotating compressor blade 42 cooperates with a compressor housing 44 to induct inlet air 46 at generally atmospheric pressure through a compressor inlet duct 48 and subsequently compress the inlet air 46. The pressurized inlet air 46 is communicated to a compressor outlet duct 50, which is in communication with a heat exchanger 52. The heat exchanger 52 operates to transfer heat energy from the pressurized inlet air 46 to increase the operating efficiency of the internal combustion engine 10 at higher engine loads. The heat exchanger 52 subsequently communicates the pressurized inlet air 46 to a first and second intake manifold 54A and 54B, respectively, via an intake duct 56. The first and second intake manifolds 54A and 54B each include a respective plenum 55A and 55B in communication with respective intake runners 57A and 57B. A throttle blade 58 is disposed within the intake duct 56 and operates to selectively and variably restrict the flow of inlet air 46 to the first and second intake manifolds 54A and 54B. The first and second intake manifolds 54A and 54B communicate inlet air 46 within the respective plenums 55A and 55B to a respective one of a plurality of intake ports 60A and 60B, defined by each of the first and second cylinder heads 18A and 18B, via the intake runners 57A and 57B. The intake ports 60A and 60B selectively introduce inlet air 46 to a respective one of the cylinder bores 16A and 16B where the inlet air 46, along with a fuel charge, is subsequently combusted in a known fashion. The fuel is preferably injected directly into the cylinder bores 16A and 16B by a common rail fuel injection system, not shown. The intake manifolds 54A and 54B, in the preferred embodiment are mounted on the outboard side of the cylinder heads 18A and 18B; i.e. the intake manifolds 54A and 54B are mounted, as shown, on the side of the cylinder heads 18A and 18B opposite the generally V-shaped cavity 24.

A first and second inlet air heater 62A and 62B are preferably mounted in close-coupled relation to the respective intake manifolds 54A and 54B. That is, the inlet air heaters 62A and 62B are mounted close to the respective plenums 55A and 55B to increase the effectiveness of the inlet air heaters 62A and 62B. The intake air heaters 62A and 62B include a respective heater element 63A and 63B. A control module 64 preferably controls the first and second inlet air heaters 62A and 62B. The control module 64 includes driver circuitry 65 to selectively and variably power the first inlet air heater 62A and the second inlet air heater 62B through an electrical series connection 66. By connecting the intake air heaters 62A and 62B in series, the power required for operation of the inlet air heaters 62A and 62B may be reduced. Additionally, the series connection 66 may enable the use of smaller, less restrictive heater elements 63A and 63B thereby reducing the inlet air flow restriction of the intake air heaters 62A and 62B.

The first and second inlet air heaters 62A and 62B operate to warm the inlet air 46 during operation of the internal combustion engine 10 at low load, low ambient air temperature conditions. By heating the inlet air 46, the combustion within the cylinders 16A and 16B can be stabilized thereby reducing white smoke production as a result of unburned hydrocarbons within the exhaust gases 21. Additionally, the inlet air heaters 62A and 62B may operate during regeneration of the DPF 36 to increase the temperature of the exhaust gas 21 thereby enhancing the combustion of accumulated particulate matter within the DPF 36. The close-coupled or adjacent positioning of the inlet air heaters 62A and 62B allows the intake air 46 to be heated immediately prior to entering the intake plenums 55A and 55B, respectively, thereby reducing the loss of heat energy to components upstream of the inlet air heaters 62A and 62B, such as the intake duct 56. By mounting the intake air heaters 62A and 62B in a close-coupled or adjacent outboard location, the vibrational and heat energy imparted to the intake air heaters 62A and 62B may be reduced compared to other mounting locations, such as within the V-shaped cavity 24, thereby increasing the durability of the intake air heaters 62A and 62B.

In addition to the driver circuitry 65, the control module 64 may also include diagnostic circuitry 68 operable to determine when the intake air heaters 62A and 62B have malfunctioned. Additionally, those skilled in the art will recognize that one or both of the diagnostic circuitry 68 and the driver circuitry 65 may be mounted with respect to one or both of the intake air heaters 62A and 62B.

While the best modes for carrying out the invention have been described in detail, those familiar with the art to which this invention relates will recognize various alternative designs and embodiments for practicing the invention within the scope of the appended claims.

1. An inlet air heater system for an internal combustion engine having a generally V-shaped cylinder configuration, the inlet air heater system comprising:
a first intake manifold having a first plenum and at least one intake runner in communication with said first plenum, wherein said first intake manifold is operable to communicate inlet air to the internal combustion engine;
an intake duct operable to communicate said inlet air to said first plenum of said first intake manifold;
a first inlet air heater mounted in close-coupled relation to said first intake manifold and operable to selectively heat said inlet air prior to said inlet air entering said first plenum; and
wherein said first intake manifold is mounted to the internal combustion engine outboard of the V-shaped cylinder configuration.

2. The inlet air heater system of claim 1, further comprising
a second intake manifold having a second plenum and at least one intake runner in communication with said second plenum, wherein said second intake manifold is operable to communicate said inlet air to the internal combustion engine;
wherein said intake duct is operable to communicate said inlet air to said second plenum of said second intake manifold;
a second inlet air heater mounted in close-coupled relation to said second intake manifold and operable to selectively heat said inlet air prior to said inlet air entering said second plenum; and
wherein said second intake manifold is mounted to the internal combustion engine outboard of the V-shaped cylinder configuration.

3. The inlet air heater system of claim 1, further comprising:
driver circuitry operable to provide power to effect operation of said first inlet air heater; and
diagnostic circuitry operable to detect malfunctions in the operation of said first inlet air heater.

4. The inlet air heater system of claim 3, wherein at least one of said driver circuitry and said diagnostic circuitry is mounted to said first inlet air heater.

5. The inlet air heater system of claim 2, further comprising:
driver circuitry operable to provide power to effect operation of said second inlet air heater; and
diagnostic circuitry operable to detect malfunctions in the operation of said second inlet air heater.

6. The inlet air heater system of claim 4, wherein at least one of said driver circuitry and said diagnostic circuitry is mounted to said second inlet air heater.

7. The inlet air heater system of claim 1, further comprising a controller having at least one of driver circuitry and diagnostic circuitry mounted remotely from said first inlet air heater.

8. The inlet air heater system of claim 2, further comprising a controller having at least one of driver circuitry and diagnostic circuitry mounted remotely from said second inlet air heater.

9. The inlet air heater system of claim 2, wherein said second inlet air heater is powered in a series in series relation with respect to said first inlet air heater.

10. An internal combustion engine having a first and second bank of cylinder bores arranged in a generally V-shaped configuration, the internal combustion engine comprising:
a first intake manifold having a plenum and at least one intake runner, said first intake manifold being mounted to the internal combustion engine in an outboard relation to the first bank of cylinder bores;
a second intake manifold having a plenum and at least one intake runner, said second intake manifold being mounted to the internal combustion engine in an outboard relation to the second bank of cylinder bores;
wherein said first and second intake manifold are sufficiently configured to communicate intake air to the internal combustion engine;
an inlet air duct operable to communicate said inlet air to each of said first and second intake manifolds;
a first inlet air heater disposed substantially adjacent to said plenum of said first intake manifold, said first inlet air heater being operable to selectively heat said inlet air prior to entering said plenum of said first intake manifold; and
a second inlet air heater disposed substantially adjacent to said plenum of said second intake manifold, said second inlet air heater being operable to selectively heat said inlet air prior to entering said plenum of said second intake manifold.

11. The internal combustion engine of claim 9, further comprising:
driver circuitry operable to provide power to effect operation of at least one of said first and second inlet air heaters; and
diagnostic circuitry operable to detect malfunctions in the operation of at least one of said first and second inlet air heaters.

12. The internal combustion engine of claim 10, wherein at least one of said driver circuitry and said diagnostic circuitry is mounted to at least one of said first and second inlet air heater.

13. The internal combustion engine of claim 9, further comprising a controller having at least one of driver circuitry and diagnostic circuitry mounted remotely from said first inlet air heaters.

14. The internal combustion engine of claim 9, wherein said second inlet air heater is powered in series relation with respect to said first inlet air heater.

15. The internal combustion engine of claim 9, wherein the internal combustion engine operates in a compression ignited mode of operation.

16. An internal combustion engine having a first and second bank of cylinder bores arranged in a generally V-shaped configuration, the internal combustion engine comprising:
a first cylinder head mounted with respect to the first bank of cylinder bores;
a second cylinder head mounted with respect to the second bank of cylinder bores;
a first intake manifold having a plenum and at least one intake runner, said first intake manifold being mounted to said first cylinder head in an outboard position;
a second intake manifold having a plenum and at least one intake runner, said second intake manifold being mounted to said second cylinder head in an outboard position;
wherein each of said first and second intake manifolds is sufficiently configured to communicate intake air to respective first and second cylinder heads;
an inlet air duct operable to communicate said inlet air to each of said first and second intake manifolds;
a first inlet air heater disposed substantially adjacent to said plenum of said first intake manifold, said first inlet air heater being operable to selectively heat said inlet air prior to entering said plenum of said first intake manifold; and
a second inlet air heater disposed substantially adjacent to said plenum of said second intake manifold, said second inlet air heater being operable to selectively heat said inlet air prior to entering said plenum of said second intake manifold.

17. The internal combustion engine of claim 15, further comprising:
driver circuitry operable to provide power to effect operation of at least one of said first and second inlet air heaters; and
diagnostic circuitry operable to detect malfunctions in the operation of at least one of said first and second inlet air heaters.

18. The internal combustion engine of claim 16, wherein at least one of said driver circuitry and said diagnostic circuitry is mounted to at least one of said first and second inlet air heaters.

19. The internal combustion engine of claim 15, further comprising a controller having at least one of driver circuitry and diagnostic circuitry mounted remotely from said first inlet air heater.

20. The internal combustion engine of claim 15, wherein said second inlet air heater is powered in series relation with respect to said first inlet air heater.

21. The internal combustion engine of claim 15, wherein the internal combustion engine operates in a compression ignited mode of operation.
